(19) United States
(12) Patent Application Publication
(10) Pub. No.: US 2002/0089922 A1
(43) Pub. Date: Jul. 11, 2002

(54) Method for enhancing music signal fidelity derived from a compact disk

(76) Inventors: Ky Tan, Costa Mesa, CA (US); Lee Tan, Costa Mesa, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/755,464

(22) Filed: Jan. 5, 2001

(51) Int. Cl. G11B 3/58

(52) U.S. Cl. 369/292; 369/72

(57) ABSTRACT

A method for enhancing music signal fidelity derived from a compact disk storage media comprises exposing the encoded surface of the compact disk music storage media to a series of color fields in sequence immediately prior to playing the compact disk.

For all corresponding material, the present application claims the prior invention date of a Document Disclosure filed with the United States Patent & Trademark Office on Nov. 6, 2000 and having an assigned Ser. No.: DD#482,137.

### BACKGROUND OF THE INVENTION

1. Field of the Invention

This invention relates generally to the fidelity of music signals originating from compact disk storage media and more particularly to a method of temporarily enhancing such signals for improved fidelity listening.

2. Description of Related Art

“Compact disk,” or CD, is the name given to a specific digital medium currently in wide ranging commercial use. This medium provides portable storage of a relatively large amount of information; approximately 700 million digital bits per CD. A laser optical system is used to read such a disk because a laser beam is able to be focused onto a relatively small physical spot, that is, in the range of a micrometer or less in diameter, and because it transmits light variations nearly instantaneously, it is ideally suited to read variations in such physical spots across the surface of the CD, at a high rate of speed; up to tens of thousands of bits per second. Such a combination is ideal for permanently storing, reading and converting to useful electrical signals, both sound and picture information with great fidelity.

However, in the field of professional music storage and reproduction, the CD and its reproductive electronic system (CD systems) does not seem to provide the highest level of fidelity demanded by the audiophile. Even the finest and most expensive CD systems are not preferred over the much older and well known mechanical turntable systems, for instance, which use vinyl pressed disks with recorded music encoded in micro-grooves within which a mechanical stylus moves.

The prior art teaches the use of CD systems, and teaches, as for instance in: U.S. Pat. No. 05,602,817, issued on Feb. 11, 1997 and entitled: “Apparatus and method for enhancing playback fidelity of compact disks,” ways and means for enhancing CD output by controlling charge conditions in the zone of interaction between the playback read head and the CD surface. The introduction of random noise to the field potentiates or enhances the improvement. However, the prior art does not teach the present simplified and very effective method for accomplishing even broader fidelity improvements. Although it is not possible to say exactly why the present invention is so effective in improving the output fidelity of music sourced from the CD it is apparently a result of pre-structuring the electromagnetic color field on the surface of the CD. The result is temporary yet effective over the temporal playing time of a typical CD recording.

### SUMMARY OF THE INVENTION

The present invention teaches certain benefits in construction and use which give rise to the objectives described below.

A method for enhancing music signal fidelity derived from a compact disk storage media comprises exposing the encoded surface of the compact disk music storage media to a series of color fields in sequence immediately prior to playing the compact disk. Preferably the color fields are tan-brown, red-brown, lime, dark brown and blue. Exposure may be for as little as one second to each of the color fields and is accomplished in the order shown.

A primary objective of the present invention is to provide an apparatus and method of use of such apparatus that provides advantages not taught by the prior art.

Another objective is to provide such an invention capable of improving the sound fidelity of music recovered from a compact disk medium.

A further objective is to provide such an invention capable of obtaining improved sound fidelity at least cost.

A still further objective is to provide such an invention capable of accomplishing improved sound fidelity without mechanical or electrical systems enhancements.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIGS. 1-5 are color fields displaying the precise colors used in the present invention method; and

FIG. 2 is a perspective view of how the invention method is carried out.

### DETAILED DESCRIPTION OF THE INVENTION

The above described drawing figures illustrate the invention in at least one of its preferred embodiments, which is further defined in detail in the following description.

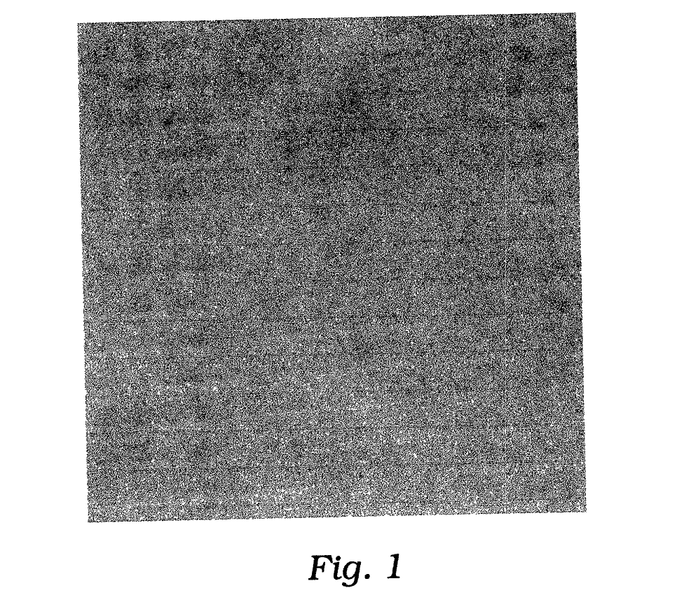

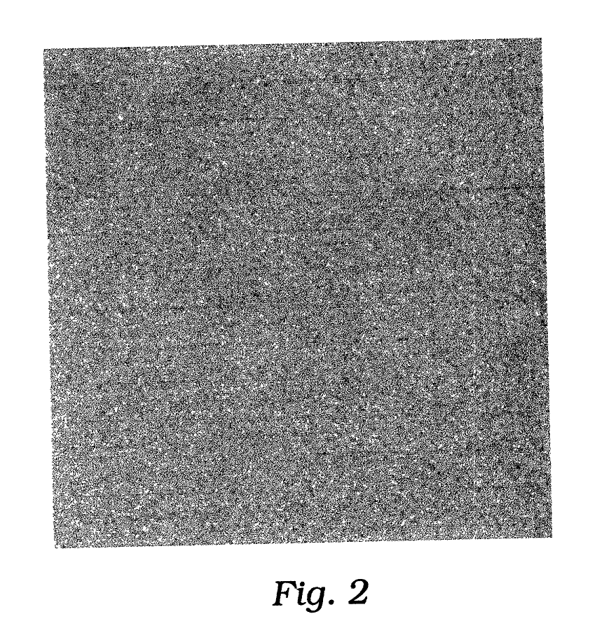

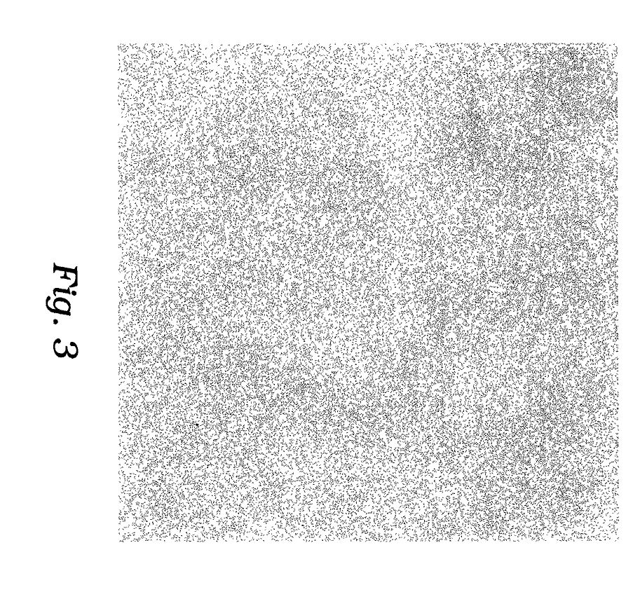

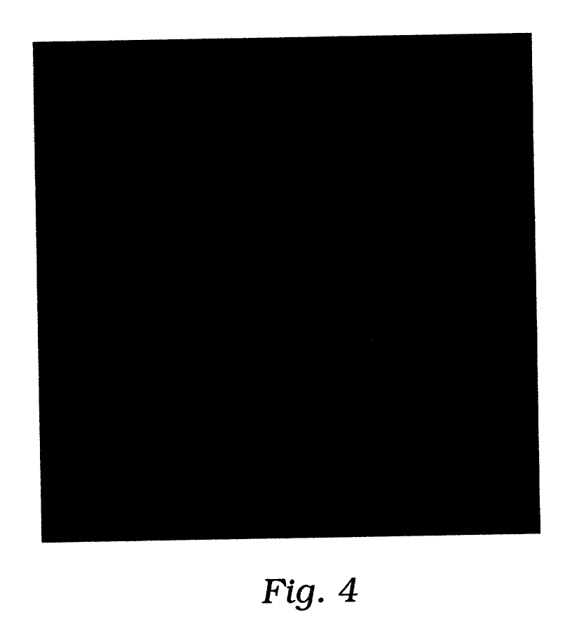

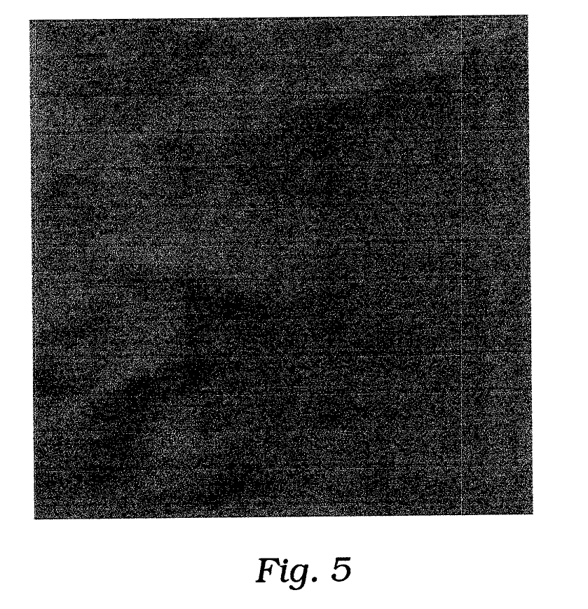

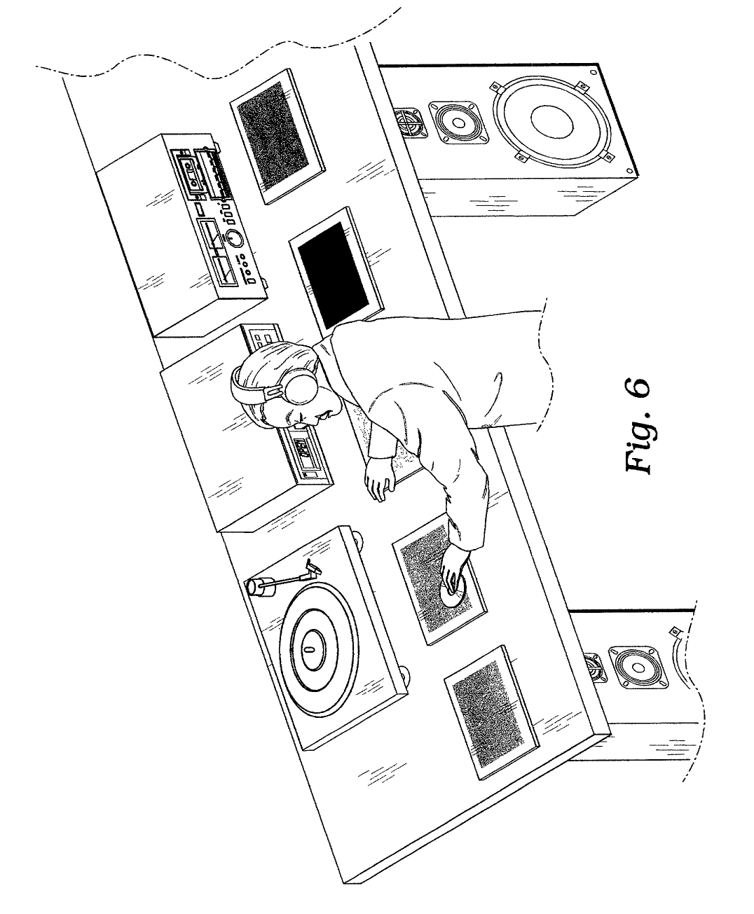

The present invention method enables the enhancing of music signal fidelity derived from a compact disk (CD) storage media. In this application, the indication “CD” shall mean all media disks that are read optically, including, but not limited to: compact disks, mini-discs, music disks, DVD disks and so on. The improvement to the reading and data transfer process in all such disks is significant whether that data results in music, spoken words, pictures or combinations of these. The method comprises exposing the encoded surface of a compact disk music storage media to a series of color fields in sequence immediately prior to playing the compact disk. Such an exposure is accomplish, as shown in FIG. 6, by placing the CD with its encoded side facing downward over each of the color fields. The color fields may be applied in various forms such as by imprinting the color onto a sheet of paper, or by generating the color as the output beam of an optical system. In whatever manner the colors of the color fields are created, it is desired to expose the entire surface of the CD to each of the colors. Preferably, the color fields comprise five such fields as shown in the figures and the specific colors are: tan, red-brown, lime, black and blue as shown in FIGS. 1-5. The preferred sequence of exposure is: tan-brown, red-brown, lime, dark brown and blue, in that order and exposure time is preferably between 1 and 5 second to each of the color fields in turn. It has been discovered that superior results are achieved when the colors are exactly as shown in FIGS. 1-5 and when the exposure sequence and duration is as defined herein. A very exhaustive research supports the present method and it has been found that small deviations in the exposure process, the exact colors of the color fields or the sequence of exposure can negate the improvement in fidelity possible through the present method.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for enhancing signal fidelity derived from a compact disk storage media, the method comprising exposing an encoded surface of a compact disk music storage media to a series of color fields in sequence immediately prior to playing the compact disk.

2. The method of claim 1 wherein the series of color fields comprise five fields.

3. The method of claim 2 wherein the series of five color fields comprise: tan-brown, red-brown, lime, dark brown and blue.

4. The method of claim 3 wherein the exposure of the encoded surface is exposed to the five color fields in the sequence: tan-brown, red-brown, lime, dark brown and blue.

5. The method of claim 4 wherein the encoded surface is exposed for between 1 and 5 second to each of the color fields.

6. The method of claim 3 wherein the colors of the color fields are precisely as shown in FIGS. 1-5.
